(19) United States
(12) Patent Application Publication
(10) Pub. No.: US 2025/0182631 A1
(43) Pub. Date: Jun. 5, 2025

(54) SYSTEM AND METHOD FOR OPTIMISING FLIGHT EFFICIENCY

(71) Applicant: SAFETY LINE SAS, Paris (FR)

(72) Inventors: Pierre JOUNIAUX, Paris (FR); Romain THIERRY-LAUMONT, Paris (FR); Emeric LAZARD, Paris (FR)

(21) Appl. No.: 18/971,538

(22) Filed: Dec. 6, 2024

Related U.S. Application Data
(63) Continuation of application No. PCT/EP2023/066336, filed on Jun. 16, 2023.

(30) Foreign Application Priority Data
Jun. 17, 2022 (FR) 2205974

(51) Int. Cl. G08G 5/54; G06F 18/231; G06F 18/2321; G08G 5/30

(52) U.S. Cl. CPC G08G 5/54; G06F 18/231; G06F 18/2321; G08G 5/30

(57) ABSTRACT

A method and system for improving the fuel efficiency of an aircraft flight, and a method for training a machine learning module to predict the most probable descent flight trajectories are disclosed. The machine learning module uses two stages of clustering and regression analysis to analyse historical flight data, so that the trained model can determine the most probable flight trajectory for the descent phase of a future/ongoing flight. This can then be used to determine an adjusted top of descent and output to the pilot of the future/ongoing flight, or used to control an associated autopilot system.

### CROSS-REFERENCED TO RELATED APPLICATIONS

This application is a continuation of International Patent Application No. PCT/EP2023/066336, filed on Jun. 16, 2023, and entitled “A SYSTEM AND METHOD FOR OPTIMISING FLIGHT EFFICIENCY,” which claims the benefit of, and priority to, French Patent Application No. 2205974, filed on Jun. 17, 2022, and entitled “SYSTEME ET PROCEDE D'OPTIMISATION D′EFFICACITE DE VOL,” the disclosures of which are hereby incorporated by reference in their entireties as if set forth herein.

This application relates to a system and method for improving the efficiency of an aircraft flight, in particular for enabling optimisation of the fuel efficiency of an aircraft during the descent phase of the flight.

FIG. 1 illustrates an example of the broad phases of a flight of an aircraft. Once the wheel blocks have been taken off an aircraft and it is ready to release its parking brake, the aircraft may depart from the gate/stand to taxi to the runway for take-off. This first phase I, is typically referred to as the taxi-out phase during which the aircraft is on the ground, i.e. at an altitude/flight level (FL) corresponding to that of the origin/departure aerodrome. Once the aircraft has taken off the ground it will progressively ascend to the desired cruise altitude. This ascent may be performed in one continuous step, or alternatively it may be performed in two or more steps, as shown in FIG. 1 with respect to phase II and phase III.

During phase II illustrated in FIG. 1, the aircraft ascends from ground level to an altitude of 5,000 feet (known as FL50—each flight level representing an altitude of 100 feet) at a first rate, and then the aircraft ascends from FL50 to FL310 (an altitude of 31,000 feet) at a second rate during phase III of the flight. It will be appreciated that these altitudes and the number of steps are simply an example any many other values may be selected in practice.

At the end of phase III, the aircraft levels off and maintains an altitude of approximately FL310 for the duration of phase IV, which will be referred to as the cruise phase. As the flight begins to approach the destination aerodrome, the aircraft will transition into phase V, during which the aircraft will start to descend at a given rate. Next, the aircraft will transition to a landing phase VI, after which the aircraft will touch down on the destination aerodrome runway and then taxi-in to the relevant gate/stand at the destination aerodrome and apply the parking brake.

At the end of the cruise phase, the aircraft leaves its cruise level and starts to descend, accordingly, this transition point is known as the top of descent (TOD). Typically, the onboard Flight Management System (FMS)/Flight Management and Guidance System (FMGS) of the aircraft's avionics will calculate a proposed TOD and constant descent path on the basis of the aircraft type, the flight plan that has been entered into the FMS, an identified Standard Terminal Arrival Route (STAR) trajectory, and sometimes an average windspeed. The STAR is sometimes referred to as a Standard Arrival Route, and it provides a set of standard paths to link the en-route portion of the flight to the final instrument approach portion of the flight.

### SUMMARY OF THE INVENTION

The invention is defined in the independent claims to which reference should now be directed. Advantageous features are set out in the dependent claims.

In a first aspect, the present disclosure relates to a method for improving the fuel efficiency of an aircraft flight. The method comprises storing, in a flight plan data store, a flight plan for the aircraft flight, the flight plan comprising a scheduled route for the aircraft flight, a scheduled landing runway at a destination aerodrome, and a scheduled arrival time and date at the destination aerodrome; and storing, in a weather data store, predicted weather data corresponding to the vicinity of the airport at the scheduled arrival time and date.

The method further comprises receiving, at a first cluster mapping module of a trained machine learning prediction module, the scheduled route for the aircraft flight, the scheduled landing runway at a destination aerodrome, and the predicted weather data corresponding to the vicinity of the destination aerodrome at the scheduled arrival time and date; determining, by the first cluster mapping module, based on the trained machine learning of the prediction module, a predicted arrival route and a predicted landing runway; determining, by a second cluster mapping module of the trained machine learning prediction module, based on the predicted arrival route and the predicted landing runway, a plurality of descent flight trajectories for the aircraft flight; filtering, by a trajectory filter of the trained machine learning prediction module, to obtain the most probable descent flight trajectories, each ranked by a conditional probability based on one or more environmental factors; determining, by a distance prediction module of the trained machine learning prediction module, a distance corresponding to each of the most probable descent flight trajectories; and outputting, to a pilot, one or more of the most probable descent flight trajectories and the corresponding distances. The trained machine learning prediction model is trained based on historical aircraft flight data.

The method further comprises determining a recommended top of descent location corresponding to the distance determined for the most probable descent flight trajectory based on a desired angle of descent and windspeed data of the predicted weather data. The recommended top of descent location is then outputted to the pilot, or to a flight director system of the aircraft's avionics for control of an associated autopilot system.

Advantageously, the first aspect of the present disclosure enables a more accurate determination of the flight path of the aircraft flight in question to be determined so that the corresponding distance to go to the destination can be identified and the updated top of descent can be determined to reduce fuel inefficiencies that may be caused by starting the descent too early or too late. The (human or auto-) pilot can then plan the descent accordingly.

The scheduled route may be the route that is pre-planned and identified in a flight plan associated with the aircraft flight. This may be represented in a number of different ways, for example a series of waypoints or a continuous trajectory. The predicted arrival route corresponds to a revised route that is determined by the method of the present disclosure and may differ from the predicted arrival route due to the impact of the predicted weather data. These arrival routes are typically standard routes and the aircraft may not fly exactly along this route. The descent flight trajectories are then more granular flight paths that identify a route of the aircraft during the descent phase of the flight.

The conditional probability is a probability associated with a respective descent flight trajectory that indicates the likelihood of that descent flight trajectory being flown when a given set of environmental factors are present. In this manner, the probability depends on the set of environmental factors. These environmental factors may, for example, relate to the current time/a time associated with another phase of the flight, visibility factors, and/or wind and other weather conditions.

Optionally, the flight director system of the aircraft's avionics may further control of the autopilot system based on an input desired angle of descent.

Optionally, the determination of the predicted arrival route and the predicted landing runway by the first clustering module may use hierarchical clustering. Optionally, the determination of the plurality of descent flight trajectories for the aircraft flight by the second clustering module may use density-based clustering. These techniques have been found to result in an efficient and accurate prediction.

Optionally, the trained machine learning prediction module may be trained based on historical aircraft flight data only corresponding to the aircraft the aircraft flight. By making predictions regarding the descent flight trajectory of an aircraft based on past flights of that individual aircraft, the inventor have found that the accuracy of the prediction can be improved, and corresponding efficiency data (such as fuel flow/consumption) can be made use of.

Optionally, the one or more environmental factors may comprise one or more of the time of day of the scheduled landing, the day of the week of the scheduled landing, the precipitation level in the vicinity of the destination aerodrome at the scheduled landing time, the visibility distance in the vicinity of the destination aerodrome at the scheduled landing time, the windspeed in the vicinity of the destination aerodrome at the scheduled landing time, or the wind direction in the vicinity of the destination aerodrome at the scheduled landing time.

In a second aspect of the present disclosure, a system for improving the fuel efficiency of an aircraft flight is disclosed. The system comprises a flight plan data store configured to store a flight plan for the aircraft flight, the flight plan comprising a scheduled route for the aircraft flight, a scheduled landing runway at a destination aerodrome, and a scheduled arrival time and date at the destination aerodrome; a weather data store configured to store predicted weather data corresponding to the vicinity of the airport at the scheduled arrival time and date; and a trained machine learning prediction module that has trained based on historical aircraft flight data.

The trained machine learning prediction module comprises a first cluster mapping module configured to receive the scheduled route for the aircraft flight, the scheduled landing runway at a destination aerodrome, and the predicted weather data corresponding to the vicinity of the destination aerodrome at the scheduled arrival time and date; the first cluster mapping module configured to determine, based on the trained machine learning of the prediction module, a predicted arrival route and a predicted landing runway; a second cluster mapping module configured to determine, based on the predicted arrival route and the predicted landing runway, a plurality of descent flight trajectories for the aircraft flight; a trajectory filter configured to filter the plurality of descent flight trajectories for the aircraft flight to obtain the most probable descent flight trajectories, each ranked by a conditional probability based on one or more environmental factors; and a distance prediction module configured to determine a distance corresponding to each of the most probable descent flight trajectories. The system further comprises an output configured to output, to a pilot, one or more of the most probable descent flight trajectories and the corresponding distances.

Advantageously, the second aspect of the present disclosure enables the system to more accurately determine the flight path of the aircraft flight in question so that the corresponding distance to go to the destination can be identified and the pilot can plan the descent accordingly.

The trained machine learning prediction module is further configured to recommend a top of descent location corresponding to the distance determined for the most probable descent flight trajectory based on a desired angle of descent and windspeed data of the predicted weather data. Advantageously, the improved accuracy of the descent distance to go and the corresponding top of descent enables the present disclosure to reduce fuel inefficiencies that may be caused by starting the descent too early or too late.

The output is further configured to output the recommended top of descent location to the pilot or to a flight director system of the aircraft's avionics for control of an associated autopilot system. Optionally the output is further configured to output, to the flight director system a desired angle of descent.

Optionally, the first clustering module may be configured to use hierarchical clustering to determine the predicted arrival route and the predicted landing runway. Optionally, the second clustering module may be configured to use density-based clustering to determine the plurality of descent flight trajectories for the aircraft flight. These techniques have been found to result in an efficient and accurate prediction.

Optionally, the trained machine learning prediction module may be trained based on historical aircraft flight data only corresponding to the aircraft the aircraft flight. By making predictions regarding the descent flight trajectory of an aircraft based on past flights of that individual aircraft, the inventor have found that the accuracy of the prediction can be improved, and corresponding efficiency data (such as fuel flow/consumption) can be made use of.

Optionally, the one or more environmental factors may comprise one or more of the time of day of the scheduled landing, the day of the week of the scheduled landing, the precipitation level in the vicinity of the destination aerodrome at the scheduled landing time, the visibility distance in the vicinity of the destination aerodrome at the scheduled landing time, the windspeed in the vicinity of the destination aerodrome at the scheduled landing time, or the wind direction in the vicinity of the destination aerodrome at the scheduled landing time.

In a third aspect of the present disclosure, a method for training a machine learning module to predict the most probable descent flight trajectories is disclosed. The trained machine learning module may be used within the first aspect of the present disclosure. The method comprises receiving an indication of a planned route for a plurality of historic aircraft flights; receiving, for each historic aircraft flight, recorded flight data from the aircraft, the recorded flight data comprising aircraft position data and aircraft heading data, the position data forming a trajectory for each aircraft flight of the plurality of historic aircraft flights; and receiving an indication of the magnetic bearing of each runway of a plurality of runways at a destination aerodrome.

The method further comprises determining, for each historic aircraft flight, which runway was used for landing of the plurality of runways at the destination aerodrome, and what the approach direction to that runway was, based on the aircraft position data and/or the aircraft heading data; performing a first cluster analysis, at a first clustering module of the machine learning module, configured to group trajectories having the same determined landing runway and approach direction into a plurality of clusters; performing, for each of the plurality of clusters, a second cluster analysis, at a second clustering module of the machine learning module, configured to group trajectories based on the distance between respective trajectories to determine a consolidated set of trajectories; and determining, for each consolidated set of trajectories, at a regression module, a conditional probability based on one or more environmental factors.

Optionally, the machine learning module may be trained based on historical aircraft flight data corresponding to a single aircraft.

Optionally, the first cluster analysis and the second cluster analysis may be based on one or more geospatial algorithms. Optionally, the first cluster analysis may be based on hierarchical clustering. Optionally, the second cluster analysis may be based on density-based clustering.

Optionally, the one or more environmental factors may comprise one or more of the time of day of the scheduled landing, the day of the week of the scheduled landing, the precipitation level in the vicinity of the destination aerodrome at the scheduled landing time, the visibility distance in the vicinity of the destination aerodrome at the scheduled landing time, the windspeed in the vicinity of the destination aerodrome at the scheduled landing time, or the wind direction in the vicinity of the destination aerodrome at the scheduled landing time.

In a fourth aspect of the present disclosure a method for predicting the optimum parameters for an aircraft descent phase is provided. The method comprises training a machine learning module by: receiving, for each of a plurality of historic aircraft flights, recorded flight data from the aircraft, the recorded flight data comprising aircraft fuel consumption data, aircraft vertical speed data, aircraft indicated airspeed data, altitude based windspeed data, and altitude based ambient temperature data; dividing a descent altitude into a plurality of altitude subsections; determining, for each altitude subsection of each of the plurality of historic aircraft flights, the time taken and the amount of fuel consumption for the aircraft to descend through the altitude subsection based on the recorded flight data; and associating each altitude subsection of each of the plurality of historic aircraft flights with the recorded windspeed, the ambient temperature and the aircraft's indicated airspeed or Mach airspeed.

The method further comprises, for a future aircraft descent having a specified flight plan data and predicted altitude based weather data, iteratively stepping through the descent speeds for each altitude subsection, and performing a prediction, using the trained machine learning module, of the overall time taken and fuel consumed for each descent; and comparing the predictions and selecting the altitude subsection descent speeds associated with the lowest fuel consumption and within a desired flight time range.

In this manner, the fourth aspect of the present disclosure may advantageously identify historical aircraft flights associated with comparable altitude bases windspeed and ambient temperature conditions, and then identify the descent speeds for each altitude subsection of the comparable historical aircraft flight having the lowest fuel consumption within an acceptable range of flight times.

Optionally, the machine learning module is trained based on historical aircraft flight data only corresponding to an individual aircraft, with subsequent predictions corresponding to the individual aircraft. Optionally, the flight plan data comprises the flight cruise level, the planned take-off weight, and the scheduled date and time of arrival.

### BRIEF DESCRIPTION OF THE DRAWINGS

Embodiments of the invention will now be described, by way of example only, and with reference to the accompanying drawings, in which:

FIG. 1 is an illustration of the broad phases of a flight of an aircraft;

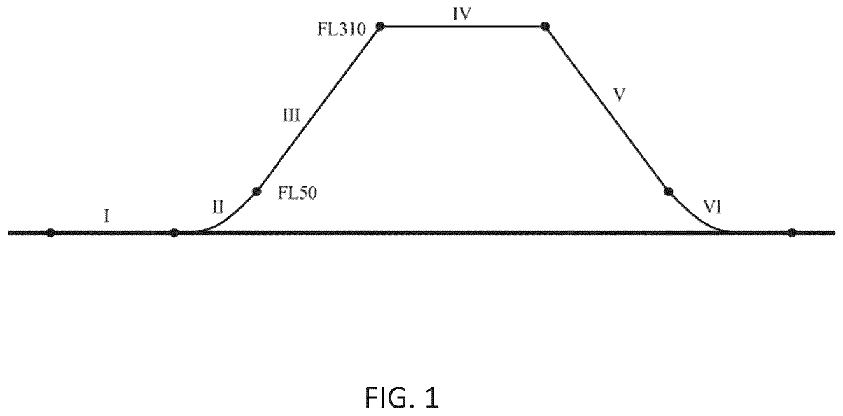

FIG. 2 is an illustration of a system for training a machine learning model to predict the descent trajectory of an aircraft according to a first aspect of the present disclosure; and

FIG. 3 is an illustration of a system for predicting the descent trajectory of an aircraft using a trained machine learning model according to the first aspect of the present disclosure.

### DETAILED DESCRIPTION

The descent path calculated by an aircraft FMS includes a Top of Descent (TOD); however, the inventors have appreciated that use of this TOD typically results in an inefficient use of fuel since the actual decent path flown often does not match that assumed by the Flight Management System (FMS) based on the flight plan and the identified Standard Terminal Arrival Route (STAR). This may be due to alternative guidance issued by Air Traffic Control (ATC), e.g. RADAR vectoring setting a series of headings to guide the aircraft to the desired runway with the appropriate aircraft-to-aircraft separation. The consequence is that the TOD computed by the FMS will have been computed based on a flown ground distance that is different to the actual ground distance flown by the aircraft during the descent.

For example, ATC may instruct the aircraft to shortcut part of a STAR during the descent. If the FMS calculated the TOD based on the published distance of the STAR and a typical 3 degree angle of descent, but the route actually flown by the aircraft between the start and end points of the STAR was shorter, then the aircraft would reach the end of the STAR with an altitude that was too high. In one example, if the ATC instructed shortcut reduced the flown distance by 24 nautical miles (in comparison to the published distance of the STAR), then the aircraft would be FL72 (24×3; 7,200 feet) too high at the end of the STAR. This would mean that the aircraft would need to deviate from this typical angle of descent, for example by applying speed brakes to increase the drag of the aircraft, thus reducing lift and increasing the rate of descent. Such manoeuvres result in a loss of energy that could have otherwise been used for gliding the aircraft down, and thus result in a higher fuel consumption for the descent than the expected or optimum level of fuel consumption.

Alternatively, the ATC may require the aircraft to extend the flight path of the STAR. This would mean that the descent calculated by the FMS would cause the aircraft to descend to the final altitude of the descent phase prior to reaching the end of the STAR. Accordingly, once this was anticipated, the aircraft would need to reduce the angle of descent during the descent phase, which requires an increase in thrust and therefore requires a corresponding increase in fuel consumption for the descent.

The inventors have appreciated that, by analysis of historical flight data, machine learning can be used to form a predictive model for predicting the descent and approach trajectory (which will simply be referred to as a descent trajectory in the following) that is likely to be used by a particular aircraft travelling between a known origin and destination pair. This predicted descent trajectory can then be used to determine a revised TOD for the aircraft's decent and this updated TOD can be output to the aircraft's pilot (for example via a flight director component), and optionally be used to control the autopilot if this is engaged.

This flight data of historical flights can be recorded in existing systems in the avionics of aircraft, such as Quick Access Recorders (QARs) or Digital Flight Data Recorders (DFDRs), which together are colloquially referred to as “black boxes”. The flight data that is recorded typically comprises data that may be time-stamped, for example:
the position of the aircraft (latitude, longitude, altitude);
indicated airspeed (IAS), using a pitot probe for example;
ground speed, using a GPS sensor for example;
instantaneous and/or average fuel flow/consumption;
a registration/identification of the aircraft;
the weight of the aircraft;
instantaneous and/or average engine thrust level;
aircraft heading;
the meteorological conditions encountered, etc.

In some examples, this flight data may be sampled at a rate of once per second and may already be accessed and recorded by airlines and other aircraft operators to monitor any potential safety events.

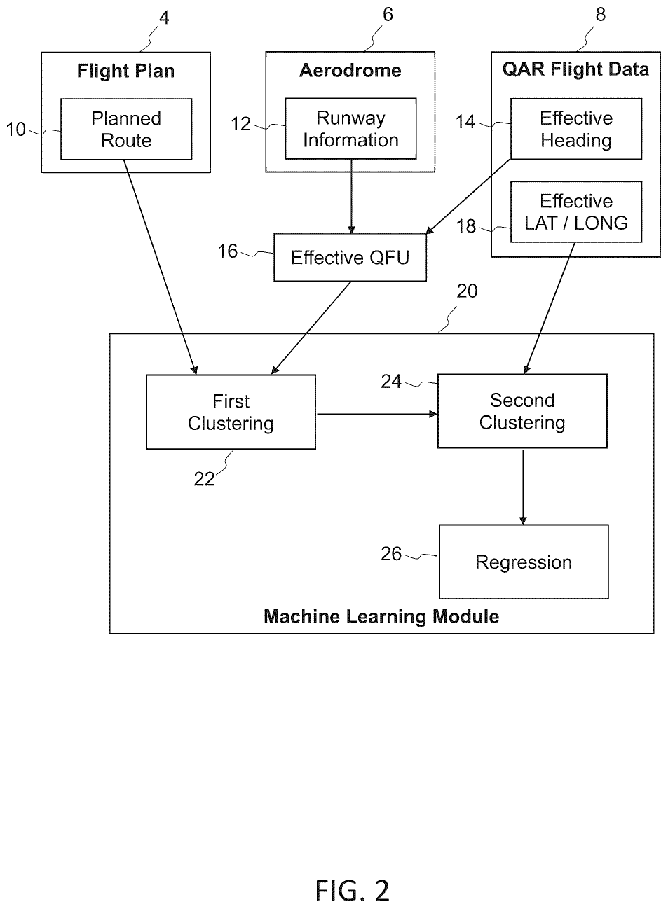

FIG. 2 is an illustration of a system for training a machine learning model to predict the descent trajectory of an aircraft according to a first aspect of the present disclosure. The system comprises a flight plan database 4, an aerodrome database 6, a QAR flight data database 8, and a machine learning module 20. The QAR flight data database 8 may be configured to obtain and store flight data for one or more identified aircraft. This may include all of the available flight data for a given aircraft, or alternatively only a portion of the available flight data.

The aerodrome database 6 comprises runway information 12 for a given aerodrome, including the orientation of each possible runway (often referred to as a QFU and expressed as a magnetic bearing). The QAR flight data database 8 comprises the instantaneous effective heading of the aircraft at each recorded point of each recorded descent. By analysing the possible runway orientations for the airport in question from the runway information 12, and the effective heading 14 of an aircraft during its descent, the particular runway that the aircraft landed at can be determined, which may be referred to as the effective QFU 16 (aerodrome runways are typically identified by their magnetic bearing). Advantageously, this effective QFU may then be correlated, in a first clustering step by a first clustering module 22 of the machine learning module 20, with the planned route 10 from the flight plan database 4 to group the flight trajectory defined by the QAR flight data for the particular flight of the aircraft in question with other trajectories that have the same landing runway as well as the same sector of arrival (i.e. arrival direction, which can be derived from an analysis of the recorded recent aircraft location data). For example, this may use hierarchical clustering analysis techniques in order to reduce the number of trajectories to a subset of trajectories that can be input into a second clustering module 24.

By clustering in this manner, the raw data of the recorded past flight trajectories can be filtered to group together trajectories that result in a landing at the same runway (same QFU), with an approach to that runway originating from a common direction (referred to above as the sector of arrival). In this manner, the first step of clustering reduces the large number of trajectories from the raw QAR flight data to a number of groups of trajectories, each group having a reduced number of flight trajectories to be processed by the second clustering module 24.

The group of trajectories having the same landing runway and sector of arrival output by the first clustering module 22 are then input into the second clustering module 24 of the machine learning module 20 for further processing using a geospatial algorithm to identify patterns within the group. For example, this may be achieved using density-based spatial clustering techniques that are appropriate to separate 2D trajectories into representative trajectory groups. In one example, this may be performed using density-based spatial clustering of applications with noise (DBSCAN). In another example, this may be performed using Symmetrised Segment-Path Distance (SSPD) clustering. This clustering may use thresholds that consider the relative distance between points on respective trajectories to determine whether the respective trajectories are in the same group/cluster.

Finally, a regression module 26 of the machine learning module 20 is used to analyse external factors and to identify the conditional probabilities of each descent and arrival trajectory pattern identified by the second clustering module 24, then linking these to the flown distance of these trajectories. These probabilities may be dynamically adjusted based on external or environmental factors such as the time of day, the day of the week, or weather events at the airport (e.g. fog or storm) in order to improve the accuracy of the resulting predictions made for a corresponding set of external factors.

In this manner, the training of the machine learning module 20 maps and clusters the trajectories of flights in order to learn the behaviour of aircraft during descent. Since the QAR flight data also includes fuel consumption data, these descent behaviours can also be linked to the performance/efficiency of the aircraft during the descent.

In one example, the above processing and machine learning is performed individually for each particular aircraft, i.e. each tail number, so that the trajectory predictions, and corresponding fuel efficiencies, are tailored specifically for the particular aircraft being considered.

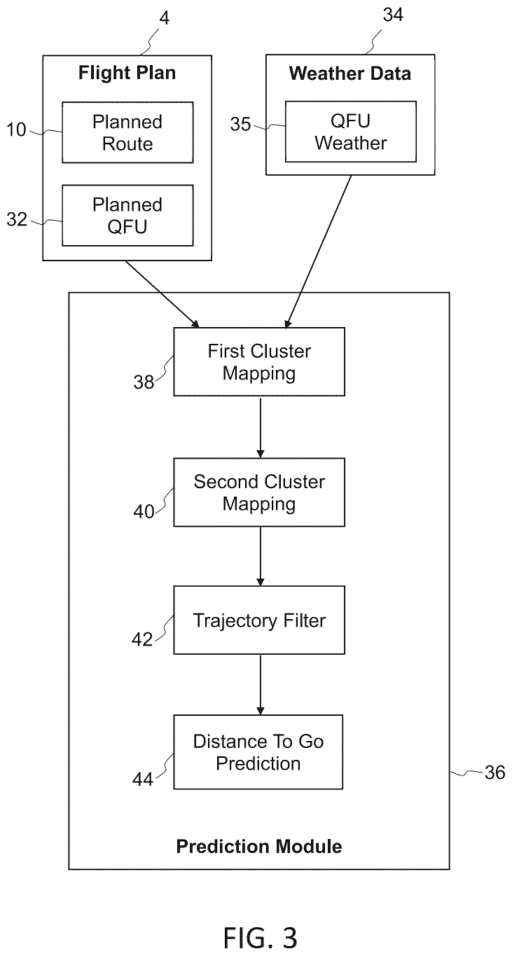

In this manner, the trained machine learning module 20 can form a prediction module 36 for providing predictions using the machine learning model and data on a planned or active/in-progress flight. FIG. 3 is an illustration of a system for predicting the descent trajectory of an aircraft using a trained machine learning model according to the first aspect of the present disclosure. As can be seen from FIG. 3, the flight plan database 4 may also store flight plan data about each current or future flight, in particular the flight plan data may include a planned route 10 and a planned landing runway orientation (QFU) 32 for each known current or future flight. This planned route 10 and planned QFU 32 data may be input into a first cluster mapping module 38 of the prediction module 36 along with further operational data, such as the weather predictions for the planned landing runway (QFU weather 35) that may be stored in a weather data database 34. This QFU weather data 35 may include wind and temperature predictions in the region of the planned landing runway/the destination aerodrome.

The output of the first cluster mapping module 38 may be an updated prediction of the expected arrival route and a predicted landing runway. This data may then be input into a second cluster mapping module 40 of the prediction module 36. The output of the second cluster mapping module 40 is a list of the most probable descent flight trajectories as ranked by the conditional probabilities discussed above. This list may be filtered by a trajectory filter module 42 to determine the most probable n trajectory predictions of the list output by the second cluster mapping module 40. For example, n may be set to “3” such that the three most likely trajectories are output by the trajectory filter module 42. Next, the flown/ground distance corresponding to each of these most probable trajectory predictions may be computed by a distance to go prediction module 44 of the prediction module 36 using standard techniques.

Optionally, further inputs may be fed into the predictive model, including the intended sector (direction) of arrival at the aerodrome, the weight of the aircraft, etc.

The prediction of the probable descent trajectory or trajectories and corresponding flown/ground distances may then be presented to the pilot of the aircraft so that they may more effectively account for this in any pilot initiated control of the aircraft during the descent.

It will be appreciated that the first cluster mapping module 38 and the second cluster mapping module 40 of the prediction module 36 may be configured in the same manner as the respective first clustering module 22 and second clustering module 24 of the machine learning module 20.

In a further aspect of the present disclosure, this predicted ground distance of the descent may be used to work backwards, using a constant rate of descent, e.g. a three degree angle of descent/glideslope, to determine a recommended TOD corresponding to the predicted descent trajectory. Since the predicted descent trajectory is expected to differ from that calculated by the FMS, it follows that the associated TOD will also be expected to differ. This recommended TOD may then be presented to the pilot for efficient manual flying, or alternatively used to cause an engaged autopilot to automatically begin the descent phase at the appropriate time.

In yet a further aspect of the present invention, the inventors have appreciated that the use of a constant indicated airspeed (IAS) throughout the descent phase does not provide the best gliding performance throughout the descent since the drag experienced during the descent will diverge from the minimum. In this regard, it is noted that the optimum lift to drag ratio is based on the true airspeed (TAS), which changes with altitude. Accordingly, the TAS will be decreasing, and the drag will be increasing, during the descent if the aircraft is held at a constant IAS, thus meaning that the optimum lift to drag ratio for an idle descent cannot be maintained, which in turn results in a higher fuel consumption for the descent.

The inventors have appreciated that the fuel consumption for the aircraft can be optimised by varying the IAS during the descent, according to a schedule identified by inputting the performance related parameters from the QAR flight data 8, including the fuel consumption and the vertical speed performance of past flights of that particular aircraft (i.e. tail number) into a further machine learning model. In this manner, the descent may be divided up into a number of subsections, each covering an altitude range, and the QAR flight data 8 may be used to determine the time taken and the amount of fuel consumption for this altitude in each of the past flights flown by the aircraft. By linking this with the IAS, the windspeed, and the temperature across this subsection of altitude for those flights, a number of performance models can be built and used to determine the fuel flow and vertical speed for different IAS, windspeeds, temperature, etc. across the changing altitude. This vertical speed learning may be transformed into a descent angle for an idle descent that takes into account the predicted windspeeds for that subsection of altitude.

The trained model may then be used to determine estimates of the amount of time taken and the amount of fuel consumed for a descent having a number of different characteristics. By iteratively altering these characteristics and performing a prediction for each, an optimum set of characteristics that will give the minimum fuel consumption while meeting a desired time constraint for the journey may be identified.

For example, the descent may be divided into three different subsections. In a first subsection the speed of the aircraft may be set to a given cruising Mach speed until a crossover flight level is reached, at which point the aircraft will switch from Mach mode to IAS mode (e.g. the readout of speed on the aircraft instrumentation will be changed from Mach units to an IAS in knots) and the speed may be set to a speed IAS1 for this second subsection. Then, the speed may be altered to a speed IAS2 for the third subsection of the descent. By inputting the cruising Mach, the crossover flight level, IAS1, IAS2, weather data, and flight plan data for the flight in question into the trained model, a prediction of the amount of time the descent will take and the amount of fuel that will be consumed during the descent may be made. Then, by iterating the cruising Mach, the crossover flight level, IAS1, and IAS2 to different values, a set of possible scenarios may be identified and associated with the corresponding predicted descent time and fuel consumption. Finally, the optimum scenario may be selected for input into the aircraft's flight director system so that this can be displayed to the pilot or used to control an active autopilot during the descent.

The weather data may comprise windspeed data that includes predictions for the windspeed at different altitudes with an interval of every 1,000 feet. Temperature data may also be included in this weather data. The flight plan data may include features such as the tail number of the aircraft, the planned initial cruise level, the planned take-off weight, the planned departure time, etc.

Accordingly, this optimisation enables a trained model for the aircraft to take into account the weight of the aircraft as well as the windspeed and temperature at the different altitudes along the descent (since the windspeed and temperature both change with flight level) and to determine optimal aircraft speeds for each subsection of altitude to provide an optimal descent angle and fuel consumption for the descent. The optimum aircraft speeds may then be combined with the ground distance of the predicted descent trajectory to determine an updated TOD prediction for input into the aircraft's flight director.

In one embodiment, these computations may be performed on a ground based computer with the predicted results then being transmitted to the aircraft avionics or a device used by the pilot onboard the aircraft. Alternatively, some or all of the computations may be performed in the aircraft avionics.

1. A method for improving the fuel efficiency of an aircraft flight, the method comprising:
storing, in a flight plan data store, a flight plan for the aircraft flight, the flight plan comprising a scheduled route for the aircraft flight, a scheduled landing runway at a destination aerodrome, and a scheduled arrival time and date at the destination aerodrome;
storing, in a weather data store, predicted weather data corresponding to the vicinity of the airport at the scheduled arrival time and date;
receiving, at a first cluster mapping module of a trained machine learning prediction module, the scheduled route for the aircraft flight, the scheduled landing runway at a destination aerodrome, and the predicted weather data corresponding to the vicinity of the destination aerodrome at the scheduled arrival time and date;
determining, by the first cluster mapping module, based on the trained machine learning of the prediction module, a predicted arrival route and a predicted landing runway;
determining, by a second cluster mapping module of the trained machine learning prediction module, based on the predicted arrival route and the predicted landing runway, a plurality of descent flight trajectories for the aircraft flight;
filtering, by a trajectory filter of the trained machine learning prediction module, to obtain the most probable descent flight trajectories, each ranked by a conditional probability based on one or more environmental factors;
determining, by a distance prediction module of the trained machine learning prediction module, a distance corresponding to each of the most probable descent flight trajectories;
outputting, to a pilot, one or more of the most probable descent flight trajectories and the corresponding distances;
determining a recommended top of descent location corresponding to the distance determined for the most probable descent flight trajectory based on a desired angle of descent and windspeed data of the predicted weather data; and
outputting the recommended top of descent location to the pilot or to a flight director system of the aircraft's avionics for control of an associated autopilot system;
wherein the trained machine learning prediction model is trained based on historical aircraft flight data.

2. The method of claim 1, wherein outputting the recommended top of descent location the flight director system further comprises outputting, to the flight director system, the desired angle of descent.

3. The method of claim 1, wherein the determination of the predicted arrival route and the predicted landing runway by the first clustering module uses hierarchical clustering.

4. The method of claim 1, wherein the determination of the plurality of descent flight trajectories for the aircraft flight by the second clustering module uses density-based clustering.

5. The method of claim 1, where the trained machine learning prediction module is trained based on historical aircraft flight data only corresponding to the aircraft the aircraft flight.

6. The method of claim 1, wherein the one or more environmental factors comprise one or more of the time of day of the scheduled landing, the day of the week of the scheduled landing, the precipitation level in the vicinity of the destination aerodrome at the scheduled landing time, the visibility distance in the vicinity of the destination aerodrome at the scheduled landing time, the windspeed in the vicinity of the destination aerodrome at the scheduled landing time, or the wind direction in the vicinity of the destination aerodrome at the scheduled landing time.

7. A system for improving the fuel efficiency of an aircraft flight, the system comprising:
a flight plan data store configured to store a flight plan for the aircraft flight, the flight plan comprising a scheduled route for the aircraft flight, a scheduled landing runway at a destination aerodrome, and a scheduled arrival time and date at the destination aerodrome;
a weather data store configured to store predicted weather data corresponding to the vicinity of the airport at the scheduled arrival time and date;
a trained machine learning prediction module that has trained based on historical aircraft flight data, the trained machine learning prediction module comprising:
a first cluster mapping module configured to receive the scheduled route for the aircraft flight, the scheduled landing runway at a destination aerodrome, and the predicted weather data corresponding to the vicinity of the destination aerodrome at the scheduled arrival time and date; the first cluster mapping module configured to determine, based on the trained machine learning of the prediction module, a predicted arrival route and a predicted landing runway;
a second cluster mapping module configured to determine, based on the predicted arrival route and the predicted landing runway, a plurality of descent flight trajectories for the aircraft flight;
a trajectory filter configured to filter the plurality of descent flight trajectories for the aircraft flight to obtain the most probable descent flight trajectories, each ranked by a conditional probability based on one or more environmental factors; and
a distance prediction module configured to determine a distance corresponding to each of the most probable descent flight trajectories; and
an output configured to output, to a pilot, one or more of the most probable descent flight trajectories and the corresponding distances;
wherein the trained machine learning prediction module is further configured to recommend a top of descent location corresponding to the distance determined for the most probable descent flight trajectory based on a desired angle of descent and windspeed data of the predicted weather data; and
wherein the output is further configured to output the recommended top of descent location to the pilot or to a flight director system of the aircraft's avionics for control of an associated autopilot system.

8. The system of claim 7, wherein the output is further configured to output, to the flight director system the desired angle of descent.

9. The system of claim 7, wherein the first clustering module is configured to use hierarchical clustering to determine the predicted arrival route and the predicted landing runway.

10. The system of claim 7, wherein the second clustering module is configured to use density-based clustering to determine the plurality of descent flight trajectories for the aircraft flight.

11. The system of claim 7, wherein the trained machine learning prediction module is trained based on historical aircraft flight data only corresponding to the aircraft the aircraft flight.

12. The system of claim 7, wherein the one or more environmental factors comprise one or more of the time of day of the scheduled landing, the day of the week of the scheduled landing, the precipitation level in the vicinity of the destination aerodrome at the scheduled landing time, the visibility distance in the vicinity of the destination aerodrome at the scheduled landing time, the windspeed in the vicinity of the destination aerodrome at the scheduled landing time, or the wind direction in the vicinity of the destination aerodrome at the scheduled landing time.

13. A method for training a machine learning module to predict the most probable descent flight trajectories, the method comprising:
receiving an indication of a planned route for a plurality of historic aircraft flights;
receiving, for each historic aircraft flight, recorded flight data from the aircraft, the recorded flight data comprising aircraft position data and aircraft heading data, the position data forming a trajectory for each aircraft flight of the plurality of historic aircraft flights;
receiving an indication of the magnetic bearing of each runway of a plurality of runways at a destination aerodrome;
determining, for each historic aircraft flight, which runway was used for landing of the plurality of runways at the destination aerodrome, and what the approach direction to that runway was, based on the aircraft position data and/or the aircraft heading data;
performing a first cluster analysis, at a first clustering module of the machine learning module, configured to group trajectories having the same determined landing runway and approach direction into a plurality of clusters;
performing, for each of the plurality of clusters, a second cluster analysis, at a second clustering module of the machine learning module, configured to group trajectories based on the distance between respective trajectories to determine a consolidated set of trajectories; and
determining, for each consolidated set of trajectories, at a regression module, a conditional probability based on one or more environmental factors.

14. The method of claim 13, wherein the machine learning module is trained based on historical aircraft flight data corresponding to a single aircraft.

15. The method of claim 13, wherein the first cluster analysis and the second cluster analysis are based on one or more geospatial algorithms.

16. The method of claim 13, wherein the first cluster analysis is based on hierarchical clustering, and wherein the second cluster analysis is based on density-based clustering.

17. The method of claim 13, wherein the one or more environmental factors comprise one or more of the time of day of the scheduled landing, the day of the week of the scheduled landing, the precipitation level in the vicinity of the destination aerodrome at the scheduled landing time, the visibility distance in the vicinity of the destination aerodrome at the scheduled landing time, the windspeed in the vicinity of the destination aerodrome at the scheduled landing time, or the wind direction in the vicinity of the destination aerodrome at the scheduled landing time.

18. A method for predicting the optimum parameters for a fuel efficient aircraft descent phase, the method comprising:
training a machine learning module by:
receiving, for each of a plurality of historic aircraft flights, recorded flight data from the aircraft, the recorded flight data comprising aircraft fuel consumption data, aircraft vertical speed data, aircraft indicated airspeed data, altitude based windspeed data, and altitude based ambient temperature data;
dividing a descent altitude into a plurality of altitude subsections;
determining, for each altitude subsection of each of the plurality of historic aircraft flights, the time taken and the amount of fuel consumption for the aircraft to descend through the altitude subsection based on the recorded flight data; and
associating each altitude subsection of each of the plurality of historic aircraft flights with the recorded windspeed, the ambient temperature and the aircraft's indicated airspeed or Mach airspeed;
for a future aircraft descent having a specified flight plan data and predicted altitude based weather data, iteratively stepping through the descent speeds for each altitude subsection, and performing a prediction, using the trained machine learning module, of the overall time taken and fuel consumed for each descent speed; and
comparing the predictions and selecting the altitude subsection descent speeds associated with the lowest fuel consumption and within a desired flight time range.

19. The method of claim 18, wherein the machine learning module is trained based on historical aircraft flight data only corresponding to an individual aircraft, with subsequent predictions corresponding to the individual aircraft.

20. The method of claim 18, wherein the flight plan data comprises the flight cruise level, the planned take-off weight, and the scheduled date and time of arrival.
